(19) United States
(12) Patent Application Publication
(10) Pub. No.: US 2010/0013441 A1
(43) Pub. Date: Jan. 21, 2010

(54) TEMPERATURE CONTROLLER

(76) Inventors: Hu Peng, Beijing (CN); Haiqing Li, Beijing (CN)

Correspondence Address: FOLEY & LARDNER LLP, 150 EAST GILMAN STREET, P.O. BOX 1497, MADISON, WI, 53701-1497, US

(21) Appl. No.: 12/356,705

(22) Filed: Jan. 21, 2009

(30) Foreign Application Priority Data
Jul. 15, 2008 (CN) 200810116677.6

(51) Int. Cl. H02J 7/04; H02J 7/00

(52) U.S. Cl. 320/162; 320/137

(57) ABSTRACT

A temperature controller is provided, which comprises a control circuit. The temperature controller further comprises a charging circuit and a chargeable battery. The charging circuit functions to charge the chargeable battery and at the same time supply power to the control circuit. In the temperature controller according to the present invention, the chargeable battery is charged by an external power source, and the chargeable battery can be reused, thereby reducing cost of the temperature controller and environmental pollution caused by using alkaline batteries.

### CROSS-REFERENCE TO RELATED PATENT APPLICATIONS

This application claims the benefit of Chinese Patent Application No. 200810116677.6 filed Jul. 15, 2008, which is incorporated herein by reference in its entirety.

### FIELD OF THE INVENTION

The present invention relates to a temperature control device of air conditioner for heat ventilating and air conditioning, particularly to a temperature controller.

### BACKGROUND OF THE INVENTION

Temperature controller is applied to air conditioner for heat ventilating and air conditioning, such as a central air conditioner or household central air conditioner in buildings or villas. Temperature controller is a common temperature control device used in air conditioner for heat ventilating and air conditioning.

Temperature controller can be used in each house or each room. A desired temperature is preset in each house, and actual blowing temperature of a certain air conditioner is compared with the preset temperature through the temperature controller. The temperature controller will control opening and closing of the air conditioner based on the difference between the actual blowing temperature and the preset temperature, thereby adjusting the temperature of the air conditioner.

With reference to FIG. 1, there is illustrated a structural diagram of a temperature controller in prior art. In the temperature controller in prior art, the control circuit 102 therein is mainly powered by the battery 101. Battery is unrecyclable energy, which can not be reused. Particularly, alkaline battery is of high cost. And also battery is a product which causes a lot of pollution. Two batteries are needed in each temperature controller, accordingly, the need for more batteries will increase with widespread use of temperature controllers. Consequently, this will result in energy waste, and also inappropriate recycling of batteries will cause severe environmental pollution.

Therefore, a solution for a temperature controller, which can solve the abovementioned problems, needs to be proposed by those skilled in the art.

### SUMMARY OF THE INVENTION

The present invention aims at providing a temperature controller, which gets rid of alkaline batteries, thereby reducing cost and environmental pollution.

The present invention particularly provides a temperature controller which comprises a control circuit, the temperature controller further comprises a charging circuit and a chargeable battery, the charging circuit functions to charge the chargeable battery and at the same time supply power to the control circuit.

Preferably, the charging circuit is connected to an external USB interface, which functions to connect an external power source, so as to supply power to the charging circuit.

Preferably, voltage of the external power source connected with the USB interface is of 5 volt direct current.

Preferably, the charging circuit includes a voltage monitoring unit and a power transistor, when it is detected by the voltage monitoring unit that input voltage of the charging circuit is higher than voltage of the chargeable battery, the power transistor will turn on and the chargeable battery will be charged by the charging circuit.

Preferably, the charging circuit is connected with a converting circuit which is in turn connected with an external alternating current power source; the converting circuit functions to convert alternating current supplied by the external alternating current power source into direct current which can be used by the charging circuit.

Preferably, the charging circuit includes a voltage monitoring unit and a power transistor, when it is detected by the voltage monitoring unit that input voltage of the charging circuit is higher than voltage of the chargeable battery, the power transistor will turn on and the chargeable battery will be charged by the charging circuit.

Preferably, the converting circuit includes a rectifying unit and a step-down unit, the rectifying unit functions to convert alternating current supplied by the external alternating current power source into direct current; the step-down unit functions to make voltage of the direct current converted by the rectifying unit become lower, and the lower direct current is supplied to the charging circuit.

Preferably, voltage of the external alternating current power source is 24 volt, 110 volt or 220 volt.

Preferably, the chargeable battery is lithium battery.

Preferably, the charging circuit is integrated with the control circuit.

Preferably, the charging circuit, the converting circuit and the control circuit are integrated with each other.

Comparing with temperature controllers in prior art, the temperature controller of the present invention has following advantages:

The temperature controller provided by the present invention includes a charging circuit and a chargeable battery. When the electricity of the chargeable battery is used up, the charging circuit, which is connected with an external power source, can charge the chargeable battery and at the same time supply power to the control circuit. Since the chargeable battery can be reused, cost of the temperature controller and environmental pollution caused by using alkaline batteries can be accordingly reduced.

### BRIEF DESCRIPTION OF THE DRAWINGS

FIG. 1 is a structural diagram of temperature controller in prior art;

FIG. 2 is a structural diagram of the temperature controller according to first embodiment of the invention;

FIG. 3 is a structural diagram of the temperature controller according to second embodiment of the invention;

FIG. 4 is a structural diagram of the converting circuit according to embodiments of the invention;

FIG. 5 is a circuit diagram of the converting circuit according to embodiments of the invention;

FIG. 6 is a circuit diagram of the charging circuit according to the invention;

FIG. 7 is a view showing using state of the charging circuit according to the invention;

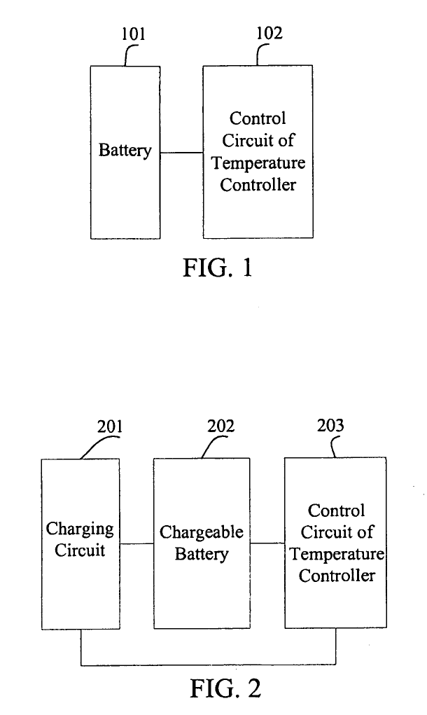

### DETAILED DESCRIPTION OF THE INVENTION

In order to make the above objects, features and advantages of the present invention more apparent, embodiments of the invention will be detailedly described with reference to the drawings in the following.

With reference to FIG. 2, there is shown the structural diagram of the temperature controller according to first embodiment of the invention.

The temperature controller according to the invention includes a charging circuit 201, a chargeable battery 202 and a control circuit 203.

The chargeable battery 202 is charged by the charging circuit 201. The control circuit 203 is powered by the chargeable battery 202 when the chargeable battery 202 is charged by the charging circuit 201.

It is preferred that lithium battery is used as the chargeable battery 202, since lithium battery is less than alkaline battery in pollution, and also charging and discharging effect of lithium battery is more excellent than that of alkaline battery.

The charging circuit 201 can charge the chargeable battery 202 by connecting to an external DC (direct current) power source of 5 volt. During the process of charging, the 5 volt DC power source may directly supply power to the control circuit 203.

The temperature controller according to embodiments of the invention includes a charging circuit 201, a chargeable battery 202 and a control circuit 203. At the time of the charging circuit 201 charging the chargeable battery 202, the charging circuit 201 also serves as a power source of the control circuit 203. In the temperature controller according to embodiments of the invention, the chargeable battery 202 is charged by an external power source, since the chargeable battery 202 can be reused repeatedly, the cost of power source of the temperature controller as well as consumption of batteries are therefore reduced.

The charging circuit 201 can be connected to the power source via interface of Universal Serial Bus (USB).

When the charging circuit 201 is connected with interface of USB, the USB interface is connected with the 5 volt DC power source, thereby providing the charging circuit 201 with power. Therefore, the charging circuit 201 can charge the chargeable battery 202.

Of course, the charging circuit 201 can be connected to the 5 volt DC power source via other interfaces and accordingly charge the chargeable battery 202.

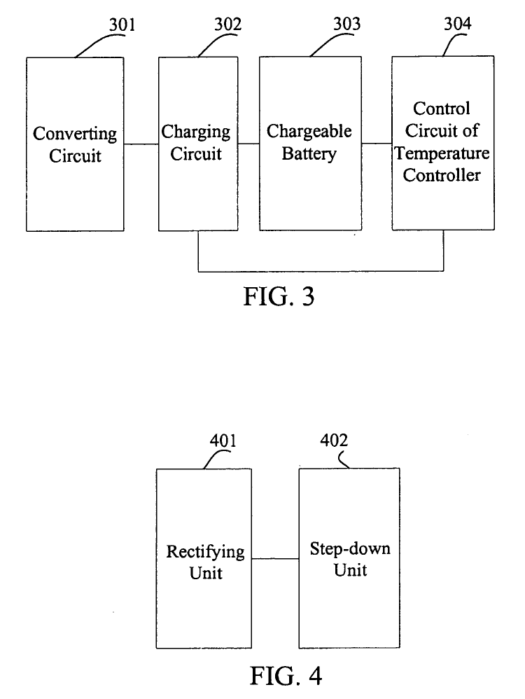

With reference to FIG. 3, there is shown the structural diagram of the temperature controller according to second embodiment of the invention.

The difference between the temperature controller of the second embodiment of the invention and the temperature controller of the first embodiment lies in that the external power source is an alternating current power source.

The temperature controller according to the second embodiment of the invention includes a converting circuit 301, a charging circuit 302, a chargeable battery 303 and a control circuit 304.

The converting circuit 301 is connected to the external alternating current power source, for converting the alternating current supplied from the external alternating current power source into direct current which can be used by the charging circuit 302.

The charging circuit 302 can charge the chargeable battery 303 while serving as power source of the control circuit 304.

The converting circuit 301 converts the alternating current supplied into 5 volt direct current and supplies the direct current to the charging circuit 302.

As a result of providing the converting circuit 301, applications of the temperature controller according to embodiments of the invention can be increased, in the case that USB interface is unavailable, alternating current can be converted into direct current, which can be used by the charging circuit 302, by the converting circuit 301, thereby charging the chargeable battery 303.

With reference to FIG. 4, there is shown the structural diagram of the converting circuit according to embodiments of the invention.

The converting circuit 301 according to embodiments of the invention may include a rectifying unit 401 and a step-down unit 402.

The rectifying unit 401 converts the external alternating current supplied into direct current.

The step-down unit 402 reduces the voltage of the direct current converted by the rectifying unit 401 and supplies the direct current of reduced voltage to the charging circuit.

In the temperature controller according to embodiments of the invention, the external alternating current can be converted by the converting circuit 301 into direct current for supplying to the charging circuit 302. With employment of the converting circuit 301, the temperature controller can be directly connected to an external power source, thereby broadening application scope of the temperature controller.

To reduce volume of the internal circuit of the temperature controller, the converting circuit 301 and the charging circuit 302 can be integrated with the control circuit 304 and provided in a single circuit board.

Of course, the converting circuit 301 and the charging circuit 302 can be designed individually and connected to the control circuit 304 by means of lead etc.

In the following, operating principles of the converting circuit according to embodiments of the invention will be described in detail with a 24 volt direct current power source taking as an example of the external power source.

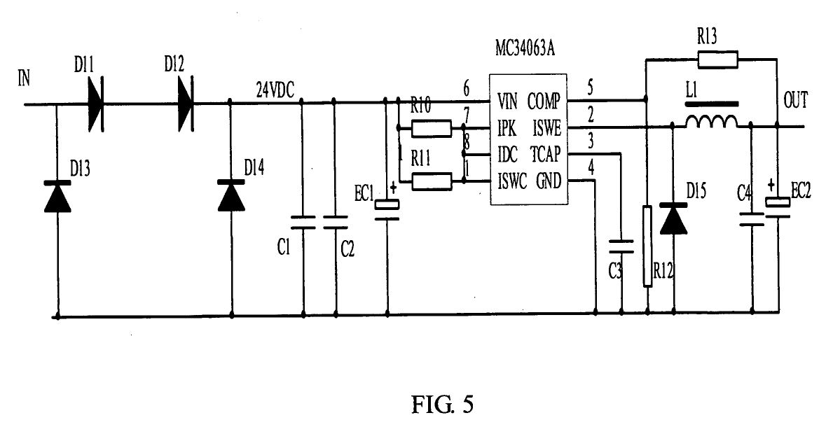

With reference to FIG. 5, there is shown the circuit diagram of the converting circuit according to embodiments of the invention.

In FIG. 5, IN represents input terminal of the external power source, the voltage at the input terminal of the external power source is 24 volt. OUT represents output terminal of the DC power source, the voltage at the output terminal of the DC power source is 5 volt.

The output terminal of the DC power source, i.e., OUT, is connected to input terminal of the charging circuit 302.

In FIG. 5, the rectifying unit 401 is a rectifying bridge formed by diodes D1, D2, D3 and D4. The rectifying bridge converts the 24 volt alternating current into 24 volt direct current. The chip U2 shown in FIG. 5 is a DC-DC converter, for converting the 24 volt direct current into 5 volt direct current. MC34063A chip can be selected to serve as chip U2.

When the current supplied from external side of the output terminal of the DC power source, i.e., OUT, is 110 volt or 220 volt alternating current, the present converting circuit can be used to convert the 110 volt or 220 volt alternating current into 5 volt direct current, and then the 5 volt direct current can be supplied to the charging circuit.

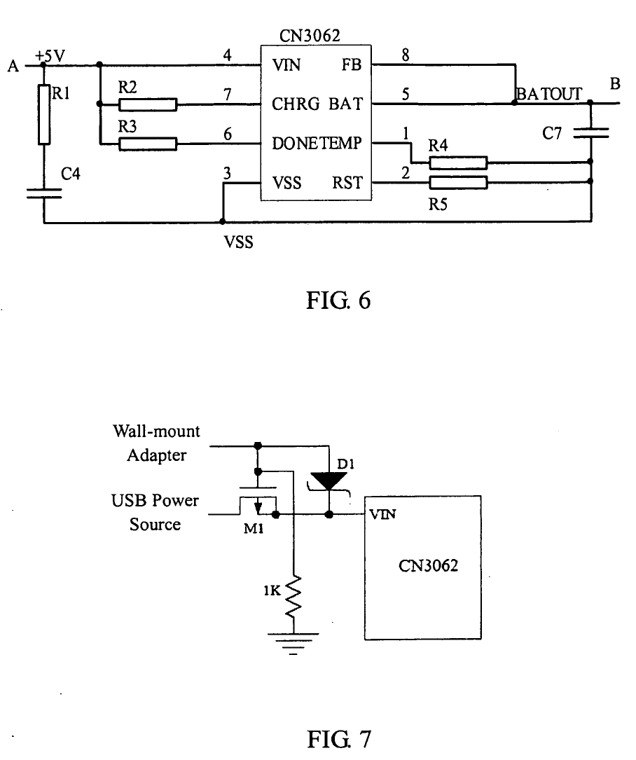

With reference to FIG. 6, there is shown the circuit diagram of the charging circuit according to the invention.

In the charging circuit according to embodiments of the invention, charging chip CN3062 is preferably used. Charging chip CN3062 is of charger circuit of constant current or constant voltage. Charging chip CN3062 can charge a single chargeable lithium battery in a manner of constant current or constant voltage.

The charging chip CN3062 is provided internally with a power transistor and meets the technical specifications of USB.

As shown in FIG. 6, terminal A is input terminal of the charging circuit, which can be connected to USB interface described in the above embodiments or output terminal of the converting circuit.

Terminal BATOUT is output terminal of the charging circuit. The terminal BATOUT can be directly connected to the chargeable battery and the control circuit, so as to supply power to the chargeable battery and the control circuit.

Of course, other chips or chip microprocessors can also be used for the charging circuit in present invention, provided that the charging requirements of the chargeable battery and the power supplying requirements of the control circuit according to the invention can be met.

USB interface and wall-mount adapter can also be used in the charging circuit simultaneously. Refer to FIG. 7, there is shown the using state of the charging circuit according to the invention.

When both USB interface and wall-mount adapter are provided, the wall-mount adapter is preferably used by the charging chip CN3062.

In FIG. 7, M1 represents P channel MOSFET, M1 functions to prevent current flowing from the wall-mount adapter to the USB interface. Schottky diode D1 can prevent the USB interface from consuming energy with resistance. A 1 k ohm resistance can be selected to serve as the resistance.

In the temperature controller of the present invention, not only USB interface but also wall-mount adapter can be used for charging. When an alternating current power source serves as power source, a converting circuit in the temperature controller of the invention can convert the alternating current into direct current, for powering the charging circuit. Since the chargeable battery can be reused, cost is accordingly reduced. Moreover, severe environmental pollution is reduced due to avoidance of using alkaline batteries.

The embodiments described above are merely used to explain the principle of the present invention, which do not constitute any kind of restrictions to the present invention. Although the present invention has been disclosed with the above preferred embodiments, the invention is not intended to be limited thereto. For those skilled in the art, various variations and modifications which are made without departing from the spirit and the scope of the invention shall fall within the scope of the invention.

What is claimed is:

1. A temperature controller comprising a control circuit, characterized in that the temperature controller further comprises a charging circuit and a chargeable battery, the charging circuit functions to charge the chargeable battery and at the same time supply power to the control circuit.

2. The temperature controller as defined in claim 1, wherein the charging circuit is connected to an external USB interface, which functions to connect an external power source, so as to supply power to the charging circuit.

3. The temperature controller as defined in claim 2, wherein voltage of the external power source connected with the USB interface is of 5 volt direct current.

4. The temperature controller as defined in claim 2, wherein the charging circuit includes a voltage monitoring unit and a power transistor, when it is detected by the voltage monitoring unit that input voltage of the charging circuit is higher than voltage of the chargeable battery, the power transistor will turn on and the chargeable battery will be charged by the charging circuit.

5. The temperature controller as defined in claim 1, wherein the charging circuit is connected with a converting circuit which is in turn connected with an external alternating current power source; the converting circuit functions to convert alternating current supplied by the external alternating current power source into direct current which can be used by the charging circuit.

6. The temperature controller as defined in claim 5, wherein the charging circuit includes a voltage monitoring unit and a power transistor, when it is detected by the voltage monitoring unit that input voltage of the charging circuit is higher than voltage of the chargeable battery, the power transistor will turn on and the chargeable battery will be charged by the charging circuit.

7. The temperature controller as defined in claim 5, wherein the converting circuit includes a rectifying unit and a step-down unit, the rectifying unit functions to convert alternating current supplied by the external alternating current power source into direct current; the step-down unit functions to make voltage of the direct current converted by the rectifying unit become lower, and the lower direct current is supplied to the charging circuit.

8. The temperature controller as defined in claim 5, wherein voltage of the external alternating current power source is 24 volt, 110 volt or 220 volt.

9. The temperature controller as defined in any one of claims 1 to 8, wherein the chargeable battery is lithium battery.

10. The temperature controller as defined in claim 1, wherein the charging circuit is integrated with the control circuit.

11. The temperature controller as defined in claim 5, wherein, the charging circuit, the converting circuit and the control circuit are integrated with each other.
